(19) United States
(12) Patent Application Publication
(10) Pub. No.: US 2012/0102164 A1
(43) Pub. Date: Apr. 26, 2012

(54) DEPLOYMENT OF LOCATION BASED APPLICATIONS WITH CROWDSOURCED STRUCTURED POINTS OF INPUT FOR DATA ENTRY

(75) Inventors: Daniel M. Gruen, Newton, MA (US); Susanne Hupfer, Lexington, MA (US); Stephen E. Levy, Saskatoon, CA (US); Michael Muller, Medford, MA (US); Kyle T. Nichols-Schmolze, Somerville, MA (US); Larissa Pschetz, Picarras (BR); Fyodor Wolf, Belmont, MA (US)

(73) Assignee: International Business Machines Corporation, Armonk, NY (US)

(21) Appl. No.: 12/909,157

(22) Filed: Oct. 21, 2010

(51) Int. Cl. G06F 15/177

(52) U.S. Cl. 709/222

(57) ABSTRACT

A method for managing location based applications providing crowdsourced structured points of input for data entry includes deploying deployable applications to a mobile computing device. Each deployable application includes a location based application component and a corresponding point of input defining structured data to be provided through a user interface control for a portion of a display for the application component. The method also includes selecting a subset of the deployable applications for display in the mobile computing device and activating one of the deployable applications in the subset for display in the mobile computing device to receive data input. Further, the method includes receiving data input for a point of input corresponding to a location based application component of the activated one of the deployable applications. Finally, the method includes storing geographic coordinates and the data input in connection with a portion of a display, such as a map display, for a corresponding application component of the activated one of the deployable applications.

### BACKGROUND OF THE INVENTION

1. Field of the Invention

The present invention relates to mobile device computing and more particularly to location based application deployment for mobile device computing.

2. Description of the Related Art

Mobile device computing pertains to the use of a mobile device such as a “smart phone” or personal digital assistant to perform computing tasks in a fashion similar to that of a personal computer. Indeed, the distinction between personal computer and mobile computing device has become blurred as the power of the mobile computing device in the marketplace today exceeds that of the personal computer just a few years ago. However, the manner in which applications are deployed to the mobile computing device often differs from the manner in which applications are deployed to the personal computer. In this regard, while the personal computer generally enjoys carte blanche in selecting applications for deployment, mobile computing devices often are dependent upon remote computing repositories controlled by an administrative entity charged with limiting the type, nature and arrangement of mobile computing applications to be deployed to one or more mobile computing devices grouped in a network of mobile computing devices.

Classically, mobile device computing provides for an extension of conventional personal computing. Specifically, within the enterprise and even in the circumstance of the individual, users of the mobile computing device utilize applications that supplement more robust applications deployed at the desktop. Examples include lightweight remote messaging clients, remote forms based data collection applications, and lightweight portal views to server stored data. Yet, users of the mobile computing device also utilize applications that capitalize on the natural ability of the mobile computing device to recognize a contemporaneous geographic location through geographic positioning system (GPS) technology, or geo-positioning data derived from a mobile telephony signal or the base station with which a mobile device communicates. Examples include mapping and navigation applications, and even newer social media applications that share the contemporaneous location of peers in a social network.

Of note, in both the desktop computing paradigm and in the mobile device computing paradigm, application deployment depends upon an ability to access a remote repository of pre-stored and cataloged applications. Whereas in the desktop environment, the end user also can deploy an application to the desktop through the use of physical media like a disc, the user of the mobile computing device largely is limited to the retrieval of a desired application over the computer communications network from a remote repository. In the latter circumstance, the end user is further limited to those applications pre-assembled and arranged for distribution.

Recent advances in mobile computing do allow a degree of customization of an application once deployed to the mobile computing device. For example, the end user of the mobile computing device can create an ad hoc arrangement of desired data (and not applications) for display in a single portal view—such as by configuring a view to include different, customized really simple syndication (RSS) feeds of data from different sources, or by configuring a view to include different fields of a form for data collection. Still, the end user cannot readily share the resulting portal view with other mobile computing device users. Mobile computing device end users can configure a map to include different points of interest for sharing with other mobile computing device users, however, those maps provide little else other than the customization by the end user once shared.

### BRIEF SUMMARY OF THE INVENTION

Embodiments of the present invention address deficiencies of the art in respect to application deployment to a mobile computing device and provide a novel and non-obvious method, system and computer program product for managing location based applications providing crowdsourced structured points of input for data entry. In an embodiment of the invention, a method for managing location based applications providing crowdsourced structured points of input for data entry is provided. The method includes deploying deployable applications to a mobile computing device. Each deployable application includes a location based application component and a corresponding point of input defining structured data to be provided through a user interface control for a portion of a display for the application component;

The method also includes selecting a subset of the deployable applications for display in the mobile computing device and activating one of the deployable applications in the subset. Further, the method includes receiving data input for a point of input corresponding to a location based application component of the activated one of the deployable applications. For instance, the point of input can include drop down box accepting data input from amongst a list of pre-defined choices of structured data. As another example, the point of input can include a set of radio buttons accepting data input from amongst a list of pre-defined choices of structured data. Finally, the method includes storing geographic coordinates and the data input in connection with a portion of a display, such as a map display, for a corresponding application component of the activated one of the deployable applications.

In another embodiment of the invention, a mobile computing data processing system can be configured for the management of location based applications providing crowdsourced structured points of input for data entry. The system can include a mobile computing device and a data store of deployable applications disposed in the mobile computing device. The system also can include a deployable application management module. The module can include program code executing in the mobile computing device. The program code in turn can select a subset of deployable applications in the data store for display in the mobile computing device, activate one of the deployable applications in the subset, receive data input for a point of input corresponding to a location based application component of the activated one of the deployable applications, and store geographic coordinates and the data input in connection with a portion of a display for a corresponding application component of the activated one of the deployable applications.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for the managing location based applications providing crowdsourced structured points of input for data entry;

FIG. 2 is a schematic illustration of a mobile computing data processing system configured for the management of location based applications providing crowdsourced structured points of input for data entry; and,

FIG. 3 is a flow chart illustrating a process for the management of location based applications providing crowdsourced structured points of input for data entry.

### DETAILED DESCRIPTION OF THE INVENTION

Embodiments of the invention provide for the management of location based applications providing crowdsourced structured points of input for data entry. In accordance with an embodiment of the invention, multiple different deployable applications can be deployed into a mobile computing device. Each deployable application can include at least one location based application component providing location based processing within the mobile computing device. Further, each deployable application can include at least one pre-defined point of input. The point of input can specify structured data input to be provided by an end user during execution of the deployable application in connection with at least a portion of the location based application component through a corresponding user interface control, for example a text field, a set of radio buttons or a list of choices from a drop-down box. A subset of the deployable applications can be selected for display in the mobile computing device and at least one of the deployable applications can be executed and displayed in the mobile computing device. Subsequently, structured data can be collected for the deployable application at a portion of a corresponding location based application component as specified by an associated point of input. Finally, the structured data can be persisted as part of the portion of the corresponding location based application component.

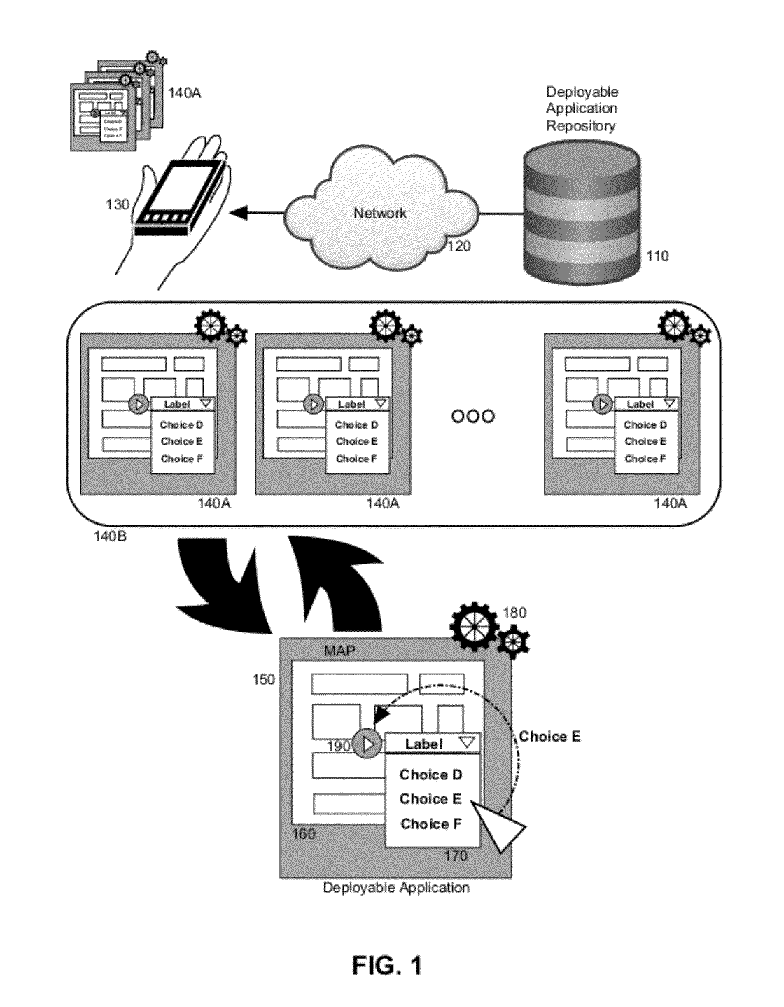

In further illustration, FIG. 1 pictorially shows a process for managing location based applications providing crowdsourced structured points of input for data entry. As shown in FIG. 1, different deployable applications 140A can be retrieved from a deployable application repository 110 over a computer communications network 120 to a mobile computing device 130. A subset 140B of the deployable applications 140A can be selected through a user interface provided in the mobile computing device 130 and a particular deployable application 150 from amongst the deployable applications 140A of the subset 140B can be selected active in order to receive structured data. In this regard, the deployable application 150 can include at least one location based application component 180 generating a visual display 160 such as a map, and also a point of input 170. Both geographic coordinates and also ancillary structured data can be collected through the point of input 170 and associated with a particular portion 190 of the visual display 160. Thereafter, the geographic coordinates and the structured data collected for the particular portion 190 of the visual display 160 can be persisted in the mobile computing device 130 in connection with the particular portion 190 of the visual display 160.

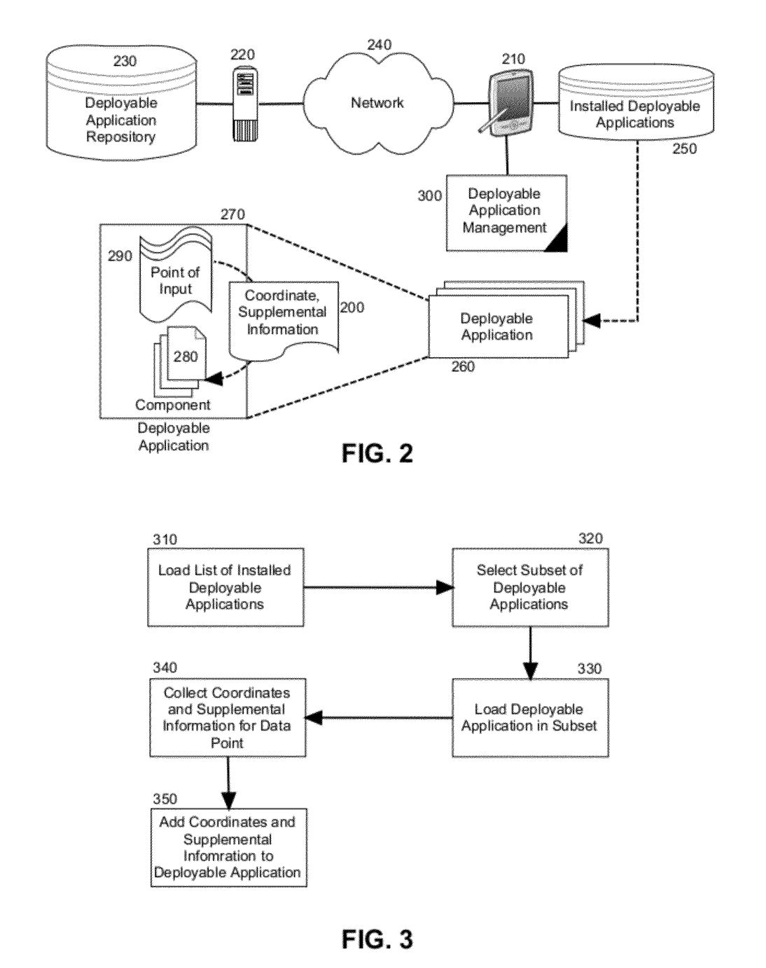

The process described in connection with FIG. 1 can be implemented in a mobile computing data processing system. In further illustration, FIG. 2 schematically depicts a mobile computing data processing system configured for the management of location based applications providing crowdsourced structured points of input for data entry. The system can include a host server 220 providing remote access to a deployable application repository 230 from over a computer communications network 240 such as the global Internet. Multiple different mobile computing devices 210 (only a single mobile computing device shown for the purpose of illustrative simplicity) can be coupled to the host server 220 in order to provide access by the mobile computing devices 210 to retrieve deployable applications from the deployable application repository 230.

Each mobile computing device 210 can include a data store of installed deployable applications 250 retrieved from the deployable application repository 230. Deployable application management module 300 can execute in memory of the mobile computing device 210 and can include program code enabled to select a subset 260 of deployable applications in the data store 250 for use and display in the mobile computing device 210. The program code of the deployable application management module 300 also can be enabled upon activating a deployable application 270 in the subset 260 to receive structured data input 200 defined by one or more points of input 290 for corresponding location based application components 280 of the deployable application 270. In this regard, the structured data input 200 for each point of input 290 can be ancillary or supplemental to geographic coordinates for a portion of a display for a corresponding one of the location based application components 280. For instance, the display can be a map display for the corresponding one of the location based application components 280. Finally, the program code of the deployable application management logic 300 can be enabled to persist the structured data input 200 in connection with a designated portion of a display for a corresponding one of the location based application components 280.

In yet further illustration of the operation of the program code of the deployable application management module 300, FIG. 3 is a flow chart illustrating a process for the management of location based applications providing crowdsourced structured points of input for data entry. Beginning in block 310, a list of installed deployable applications in the mobile computing device can be loaded and a subset of deployable applications in the list can be selected in block 320. In block 330, a particular one of the deployable applications in the subset can be loaded and activated to receive the input of structured data, and in block 340, geographic coordinates for a portion of a display for a location based application component in the particular one of the deployable applications can be computed. Further in block 340, supplemental information defined by a point of input for the location based application component can be collected according to the point of input. Finally, in block 350, both the geographic coordinates and the supplemental information can be persisted in connection with the portion of the display of the location based application component of the particular one of the deployable applications.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for managing location based applications providing crowdsourced structured points of input for data entry, the method comprising:
deploying a plurality of deployable applications to a mobile computing device, each deployable application comprising a location based application component and a corresponding point of input defining structured data to be provided through a user interface control for a portion of a display for the application component;
selecting a subset of the deployable applications for display in the mobile computing device;
activating one of the deployable applications in the subset for display in the mobile computing device to receive data input;
receiving data input for a point of input corresponding to a location based application component of the activated one of the deployable applications; and,
storing geographic coordinates and the data input in connection with a portion of a display for a corresponding application component of the activated one of the deployable applications.

2. The method of claim 1, wherein receiving data input for a point of input corresponding to a location based application component of the activated one of the deployable applications comprises receiving data input for a point of input comprising a drop down box accepting data input from amongst a list of pre-defined choices of structured data, the point of input corresponding to a location based application component of the activated one of the deployable applications.

3. The method of claim 1, wherein receiving data input for a point of input corresponding to a location based application component of the activated one of the deployable applications comprises receiving data input for a point of input comprising a set of radio buttons accepting data input from amongst a list of pre-defined choices of structured data, the point of input corresponding to a location based application component of the activated one of the deployable applications.

4. The method of claim 1, wherein storing geographic coordinates and the data input in connection with a portion of a display for a corresponding application component of the activated one of the deployable applications, comprises storing geographic coordinates and the data input in connection with a portion of a map display for a corresponding application component of the activated one of the deployable applications.

5. A mobile computing data processing system configured for the management of location based applications providing crowdsourced structured points of input for data entry, the system comprising:
a mobile computing device;
a data store of deployable applications disposed in the mobile computing device; and,
a deployable application management module comprising program code executing in the mobile computing device, the program code selecting a subset of deployable applications in the data store for display in the mobile computing device, activating one of the deployable applications in the subset for display in the mobile computing device to receive structured data input, receiving data input for a point of input corresponding to a location based application component of the activated one of the deployable applications, and storing geographic coordinates and the data input in connection with a portion of a display for a corresponding application component of the activated one of the deployable applications.

6. The system of claim 5, wherein the point of input comprises a drop down box accepting data input from amongst a list of pre-defined choices of structured data.

7. The system of claim 5, wherein the point of input comprises a set of radio buttons accepting data input from amongst a list of pre-defined choices of structured data.

8. The system of claim 5, wherein the display comprises a map display for a corresponding application component of the activated one of the deployable applications.

9. A computer program product for managing location based applications providing crowdsourced structured points of input for data entry, the computer program product comprising:
a computer readable storage medium having computer readable program code embodied therewith, the computer readable program code comprising:
computer readable program code for deploying a plurality of deployable applications to a mobile computing device, each deployable application comprising a location based application component and a corresponding point of input defining structured data to be provided through a user interface control for a portion of a display for the application component;
computer readable program code for selecting a subset of the deployable applications for display in the mobile computing device;
computer readable program code for activating one of the deployable applications in the subset for display in the mobile computing device to receive structured data input;
computer readable program code for receiving data input for a point of input corresponding to a location based application component of the activated one of the deployable applications; and,
computer readable program code for storing geographic coordinates and the data input in connection with a portion of a display for a corresponding application component of the activated one of the deployable applications.

10. The computer program product of claim 9, wherein the computer readable program code for receiving data input for a point of input corresponding to a location based application component of the activated one of the deployable applications comprises computer readable program code for receiving data input for a point of input comprising a drop down box accepting data input from amongst a list of pre-defined choices of structured data, the point of input corresponding to a location based application component of the activated one of the deployable applications.

11. The computer program product of claim 9, wherein the computer readable program code for receiving data input for a point of input corresponding to a location based application component of the activated one of the deployable applications comprises computer readable program code for receiving data input for a point of input comprising a set of radio buttons accepting data input from amongst a list of pre-defined choices of structured data, the point of input corresponding to a location based application component of the activated one of the deployable applications.

12. The computer program product of claim 9, wherein the computer readable program code for storing geographic coordinates and the data input in connection with a portion of a display for a corresponding application component of the activated one of the deployable applications, comprises computer readable program code for storing geographic coordinates and the data input in connection with a portion of a map display for a corresponding application component of the activated one of the deployable applications.
